(19) United States
(12) Patent Application Publication
(10) Pub. No.: US 2006/0162549 A1
(43) Pub. Date: Jul. 27, 2006

(54) Air pump having cylinder with non-circular configuration in cross section

(76) Inventor: Lo-Pin Wang, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/083,880

(22) Filed: Mar. 21, 2005

(30) Foreign Application Priority Data
Jan. 24, 2005 (TW) 94201291

(51) Int. Cl. F16J 1/10

(52) U.S. Cl. 92/129; 92/177

(57) ABSTRACT

An air pump has a cylinder with a non-circular configuration in a cross section. A bar has a handle and an adapter at opposite ends respectively. A piston having a configuration fitted with the cylinder is connected to the adapter. A nozzle is communicated with the cylinder. A pivot is provided between the bar and the adapter, such that the handle is free for rotation relative to the cylinder.

### BACKGROUND OF THE INVENTION

1. Field of the Invention

The present invention relates generally to an air pump, and more particularly to an air pump having a cylinder with a non-circular configuration in a cross section.

2. Description of the Related Art

Conventional air pumps have a circular cylinder bore and a piston reciprocated in the cylinder bore by drawing or pushing a bar with a handle out of the cylinder connected to the piston. The bar, handle and piston are free for rotation relative to the cylinder because of the circular cylinder bore and the piston, such that the handle is rotated to mate the user for inflation. The air pumps are made with circular cylinder always that restricts design of the air pump.

### SUMMARY OF THE INVENTION

The primary objective of the present invention is to provide an air pump, which has a cylinder with a non-circular configuration in a cross section and the handle still can be rotated freely.

According to the objective of the present invention, an air pump comprises a cylinder with a non-circular configuration in a cross section. A bar has a handle and an adapter at opposite ends respectively. A piston having a configuration fitted with the cylinder is connected to the adapter. A pivot is provided between the bar and the piston or between the handle and the bar, such that the handle is free for rotation relative to the cylinder.

### BRIEF DESCRIPTION OF THE DRAWINGS

FIG. 1 is a perspective view of a preferred embodiment of the present invention;

FIG. 2 is a perspective view of the cylinder of the preferred embodiment of the present invention;

FIG. 3 is an exploded view in parts of the preferred embodiment of the present invention;

FIG. 4 is a sectional view in parts of the preferred embodiment of the present invention, and

FIG. 5 is another sectional view in parts of the preferred embodiment of the present invention.

### DETAILED DESCRIPTION OF THE INVENTION

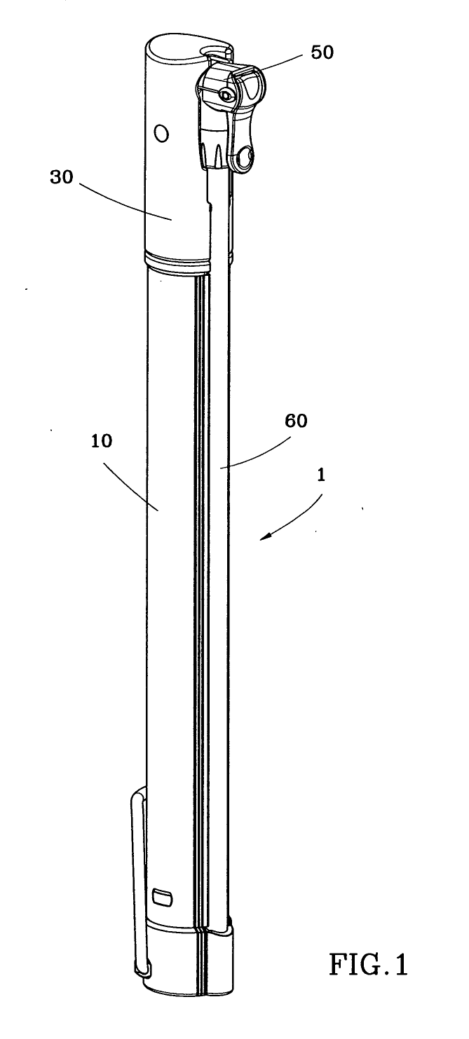

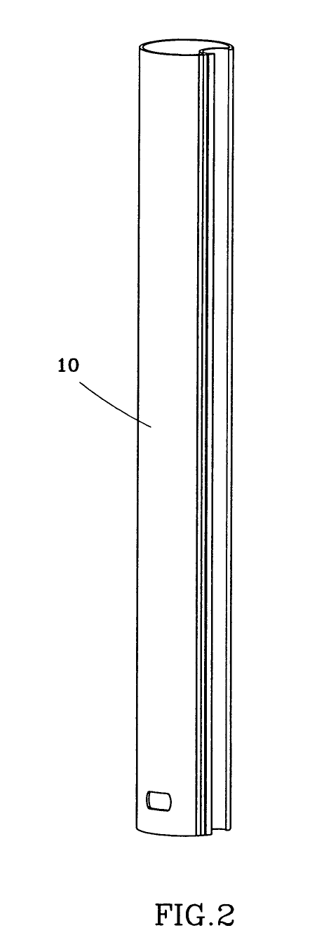

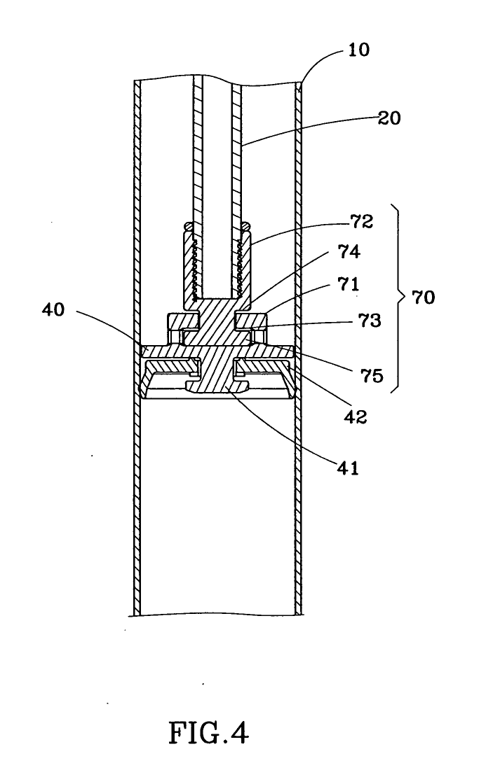

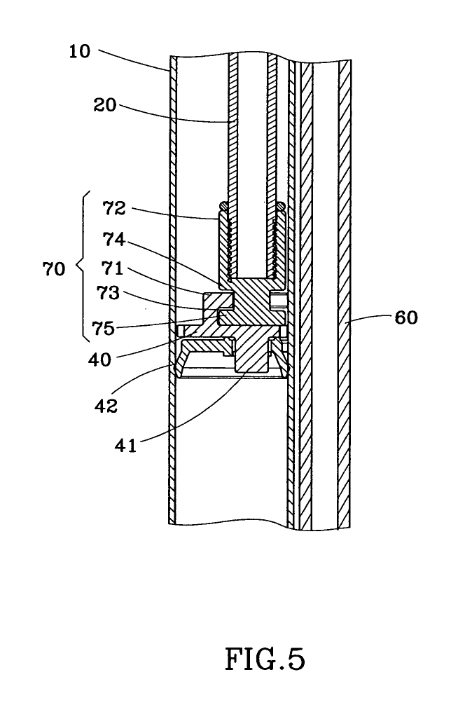

As shown in FIGS. 1-3, an air pump 1 of the preferred embodiment of the present invention comprises a cylinder 10 with a substantially C-shaped cross section configuration. As shown in FIG. 1, FIG. 4 and FIG. 5, a bar 20 has a handle 30 at an end out of the cylinder 10 and an adapter 40 at an opposite end in the cylinder 10. The adapter 40 has a ring 41 to be connected to a piston 42. A configuration of the piston 40 is fitted with the cylinder 10. As shown in FIG. 1, a nozzle 50 is communicated with the cylinder 10 via a hose 60. The present invention is characterized in that the piston has a cross-section fitted with the cylinder 10 and stays in contact with an inner wall of the cylinder, and a pivot is provided between the handle 30 and bar 20 or between the adapter 40 and the bar 20, such that the handle 30 is free for rotation relative to the cylinder 10 by manipulation.

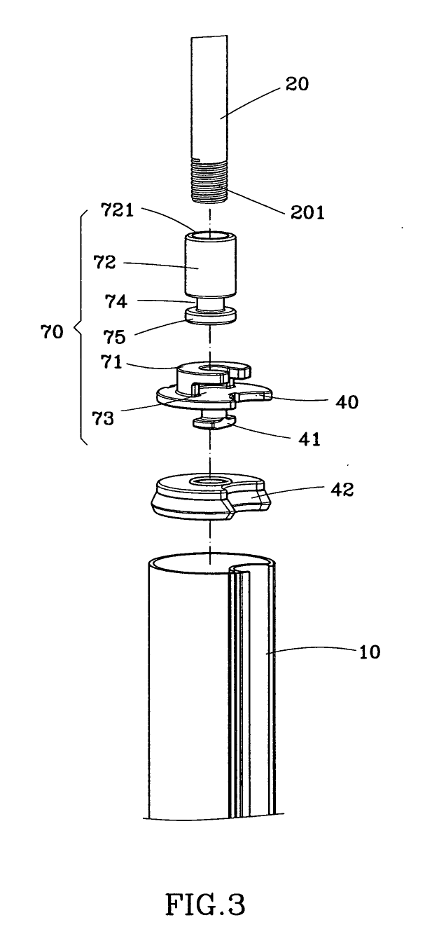

As shown in FIGS. 3-5, in the present embodiment, a pivot 70 is provided between the bar 20 and the adapter 40, which has a C-shaped lock ring 71 and a post 72. The lock ring 71 is bonded to a top of the adapter 40 with a space 73 therebetween. The bar 20 has threads 201 adjacent to the bottom end thereof, and the post 72 has a threaded bore 721 at a top thereof to be mated with the bar 20. The post 72 may be bonded to the bar 20 by any known art, such as hook or clip. The post 72 has an annular slot 74 and a rim 75 under the slot 74. The lock ring 71 is engaged with the slot 74 of the post 72 with the rim 75 in the space 73, such that the post 72 is connected to the lock ring 71 but free for rotation. As a result, the handle is exerted to reciprocate the piston 42 in the cylinder 10 and is free for rotation relative to the cylinder 10.

The engagement of the C-shaped lock ring 71 and the post 72 is capable of the rotation of the handle 30, such that the air pump 1 of the present invention is not restricted in a specific orientation for operation.

It is known that the C-shaped lock ring 71 may be bonded to the bar 20 and the post 72 is bonded to the adapter 40. The alternated structures also can be the annular 74 mated with the C-shaped lock ring 71 or the rim 73 mated with the space 73 to have the post 72 connected to the C-shaped lock ring 71 but still free for rotation.

Whether the pivot is provided between the bar and the handle or between the bar and the adapter, they should be still in the scope of the present invention.

What is claimed is:

1. An air pump, comprising a cylinder with a non-circular configuration in a cross section, a bar having a handle and an adapter at opposite ends respectively, a piston having a configuration fitted with the cylinder and connected to the adapter, a nozzle communicated with the cylinder and a pivot provided between the handle and the bar or between the bar and the piston, such that the handle is free for rotation relative to the cylinder.

2. The air pump as defined in claim 1, wherein the pivot is between the bar and the adapter having a C-shaped lock ring and a post on the bar and the adapter respectively, which the post has an annular slot to be engaged with the lock ring, such that the bar is connected to the adapter and free for rotation.

3. The air pump as defined in claim 2, wherein the post has a threaded bore at an end thereof to be mated with the bar and the lock ring is bonded to a top of the adapter.

4. The air pump as defined in claim 1, wherein the pivot is between the bar and the adapter having a C-shaped lock ring and a post on the bar and the adapter respectively, which a space is left under the lock ring and the post has an annular slot to be engaged with the lock ring and a rim under the slot to be received in the space, such that the bar is connected to the adapter and free for rotation.

5. The air pump as defined in claim 4, wherein the post is bonded to the bar and the lock ring is bonded to a top of the adapter with the space between the adapter and the lock ring.

6. The air pump as defined in claim 1, wherein the adapter has a ring to be connected to the piston.

7. The air pump as defined in claim 1, wherein the adapter has a configuration fitted with the configuration of the cylinder.
